(19) United States
(12) Patent Application Publication
(10) Pub. No.: US 2026/0138703 A1
(43) Pub. Date: May 21, 2026

(54) CARRIER PART TO RETAIN BOTTOM-OUT BUMPER

(71) Applicant: Fox Factory, Inc., Duluth, GA (US)

(72) Inventors: William M. Becker, Aptos, CA (US); Damon Gilbert, Aptos, CA (US)

(21) Appl. No.: 19/354,178

(22) Filed: Oct. 9, 2025

Related U.S. Application Data
(60) Provisional application No. 63/720,875, filed on Nov. 15, 2024.

(51) Int. Cl. B62K 25/08; B62K 19/40

(52) U.S. Cl. CPC B62K 25/08; B62K 19/40

(57) ABSTRACT

A bumper carrier for a suspension fork includes a base plate and a retention feature. The retention feature may be configured to secure a bottom-out bumper to the bumper carrier. In some aspects, the retention feature comprises an annular wall integral with the base plate, which may at least partially nest the bottom-out bumper. The annular wall can define an annular notch surrounded by protrusions to retain the bottom-out bumper. The base plate may include apertures for coupling to a topcap. In some implementations, the bumper carrier includes at least one elastomeric portion permanently affixed to the base plate, which may be overmolded or adhesively bonded.

### CROSS-REFERENCE TO RELATED APPLICATION

This application claims the benefit of and priority to U.S. Provisional Ser. No. 63/720,875 filed Nov. 15, 2024, entitled “Inverted Suspension Fork with Improved Air Spring and Lubrication,” the contents of which being incorporated by reference in their entirety herein.

### TECHNICAL FIELD

The present disclosure relates generally to suspension systems for vehicles and, more particularly, to suspension forks with bottom-out bumper assemblies and/or air pressure release assemblies for bicycles and other two-wheeled or multi-wheeled vehicles.

### BACKGROUND

Suspension forks in bicycles and other vehicles utilize bottom-out systems to prevent metal-to-metal contact at full compression. These systems typically employ cushioning bumpers positioned near the end of travel of a suspension fork to absorb impacts. As suspension fork designs have evolved, maximizing bushing overlap to reduce friction and improve performance has become a focus. In inverted fork designs, where the lower tubes are longer than traditional forks, positioning of the bottom-out system presents challenges. It is desirable to develop bottom-out systems that effectively absorb impact forces while maintaining optimal bushing overlap.

### BRIEF SUMMARY

Various embodiments are disclosed for an inverted suspension fork having a bottom-out bumper assembly. According to an aspect of the present disclosure, a suspension fork is provided. The suspension fork includes an upper tube, a lower tube slidably engaged with the upper tube, the upper tube and lower tube collectively defining an interior, a topcap positioned on the upper tube, and a bottom-out assembly disposed within the interior. The bottom-out assembly comprises a bumper carrier positioned proximate to the topcap and an elastomeric bottom-out bumper affixed to the bumper carrier.

The bumper carrier may comprise a receiving surface and an annular wall coupled to the receiving surface, and the elastomeric bottom-out bumper is at least partially nested within and surrounded by the annular wall. The elastomeric bottom-out bumper may have a surface facing the bumper carrier that contacts the receiving surface of the bumper carrier. The bumper carrier may comprise a base plate, and the elastomeric bottom-out bumper may be overmolded or otherwise affixed onto the base plate. The elastomeric bottom-out bumper may comprise a first elastomeric portion overmolded or affixed onto a first side of the base plate, and a second elastomeric portion overmolded or affixed onto a second side of the base plate. At least one of the first elastomeric portion and the second elastomeric portion may comprise one or more recessed portions and one or more stepped portions, the one or more stepped portions having a height relative to the base plate that is greater than a height of the one or more recessed portions. The suspension fork may further comprise an air pressure relief assembly integrated with the topcap.

According to another aspect of the present disclosure, a bottom-out assembly for a suspension fork is provided. The bottom-out assembly includes a bumper carrier configured to be positioned proximate to a topcap of the suspension fork, and an elastomeric bottom-out bumper affixed to the bumper carrier. The bumper carrier comprises a receiving surface and an annular wall coupled to the receiving surface, and the elastomeric bottom-out bumper is at least partially nested within the annular wall.

The elastomeric bottom-out bumper may have a surface facing the bumper carrier that contacts the receiving surface of the bumper carrier. The bumper carrier may comprise a plurality of apertures configured to receive fasteners for coupling the bumper carrier to the topcap. The bottom-out assembly may further comprise a seal positioned between the bumper carrier and the topcap. The bumper carrier may be formed of a rigid material. The annular wall may define an annular groove that retains the elastomeric bottom-out bumper. The annular groove may be surrounded by one or more protrusions that retain the elastomeric bottom-out bumper within the annular groove.

According to another aspect of the present disclosure, a bottom-out assembly for a suspension fork is provided. The bottom-out assembly includes a bumper carrier configured to be positioned proximate to a topcap of the suspension fork, an elastomeric bottom-out bumper affixed to the bumper carrier, and an air pressure relief assembly integrated with the bumper carrier. The air pressure relief assembly comprises a release mechanism and an air seal, wherein actuation of the release mechanism disengages the air seal to equalize air pressure within the suspension fork and outside ambient air pressure.

The bumper carrier may comprise a base plate, and the elastomeric bottom-out bumper may be overmolded onto the base plate. The elastomeric bottom-out bumper may comprise a first elastomeric portion overmolded onto a first side of the base plate, and a second elastomeric portion overmolded onto a second side of the base plate. At least one of the first elastomeric portion and the second elastomeric portion may comprise a recessed portion and a stepped portion, the stepped portion having a height relative to the base plate that is greater than a height of the recessed portion. The air pressure relief assembly may further comprise a spring configured to bias the release mechanism to maintain the air seal in an engaged position. The release mechanism may comprise a button positioned on an upper surface of the topcap, and actuation of the button may compress the spring to disengage the air seal.

According to another aspect of the present disclosure, a suspension fork is provided. The suspension fork includes an upper tube, a lower tube slidably engaged with the upper tube, and a carrier part positioned in the upper tube. The carrier part is configured to retain a bottom-out bumper.

The carrier part may comprise a receiving surface and an annular wall coupled to the receiving surface, the annular wall configured to at least partially nest the bottom-out bumper. The annular wall may define an annular groove that retains the bottom-out bumper. The annular groove may be surrounded by protrusions that retain the bottom-out bumper. The carrier part may comprise a base plate, and the bottom-out bumper may be overmolded onto the base plate. The bottom-out bumper may comprise a first elastomeric portion overmolded onto a first side of the base plate, and a second elastomeric portion overmolded onto a second side of the base plate. At least one of the first elastomeric portion and the second elastomeric portion may comprise a recessed portion and a stepped portion, the stepped portion having a height relative to the base plate that is greater than a height of the recessed portion.

According to another aspect of the present disclosure, a bumper carrier for a bottom-out assembly of a suspension fork is provided. The bumper carrier includes a base plate and a retention feature coupled to the base plate. The retention feature is configured to secure a bottom-out bumper to the bumper carrier.

The retention feature may comprise an annular wall integral with the base plate, the annular wall configured to at least partially nest the elastomeric bottom-out bumper. The annular wall may define an annular notch configured to retain the bottom-out bumper, wherein the annular notch is surrounded by protrusions that retain the bottom-out bumper within the annular notch. The bottom-out bumper may be formed of an elastomeric material. The base plate may comprise a plurality of apertures configured to receive fasteners for coupling the bumper carrier to a topcap of the suspension fork. The retention feature may act a snap-fit mechanism configured to detachably secure the bottom-out bumper to the bumper carrier, where the bottom-out bumper may snap into and form a connection with the bumper carrier. The retention feature may comprise a threaded portion configured to threadably engage with a corresponding threaded portion on the bottom-out bumper.

According to another aspect of the present disclosure, a bumper carrier for a suspension fork is provided. The bumper carrier includes a base plate configured to be coupled to a component of the suspension fork, and at least one elastomeric portion permanently affixed to the base plate.

According to other aspects of the present disclosure, the bumper carrier may include one or more of the following features. The at least one elastomeric portion may be overmolded onto the base plate. The at least one elastomeric portion may comprise a first elastomeric portion permanently affixed to a first side of the base plate and a second elastomeric portion permanently affixed to a second side of the base plate. At least one of the first elastomeric portion and the second elastomeric portion may comprise a recessed portion and a stepped portion, the stepped portion having a height relative to the base plate that is greater than a height of the recessed portion. The base plate may comprise a plurality of apertures configured to receive fasteners for coupling the bumper carrier to the component of the suspension fork, wherein the component is a topcap. The at least one elastomeric portion may be bonded to the base plate using an adhesive.
This summary is provided to introduce a selection of concepts in a simplified form that are further described below in the detailed description. The summary is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a front view of an inverted suspension fork according to various embodiments of the present disclosure.

FIG. 2 is a front view of the inverted suspension fork of FIG. 1 shown in full compression according to various embodiments of the present disclosure.

FIG. 3 is a front view of the inverted suspension fork of FIG. 1 in full extension according to various embodiments of the present disclosure.

FIG. 4 is a cross-sectional view of the inverted suspension fork of FIG. 1 according to various embodiments of the present disclosure.

FIG. 5 is a cross-sectional view of an upper portion of the suspension fork of FIG. 1 according to various embodiments of the present disclosure.

FIG. 6 is a cross-sectional view of a damper assembly side of the upper portion of the suspension fork of FIG. 5 according to various embodiments of the present disclosure.

FIG. 7 is a cross-sectional view of an air-spring assembly side of the upper portion of the suspension fork of FIG. 5 according to various embodiments of the present disclosure.

FIGS. 8 and 9 are exploded views of a topcap, a bumper carrier, and a bottom-out bumper, among other components for use in the suspension fork according to various embodiments of the present disclosure.

FIG. 10 is an enlarged perspective view of an overmolded bottom-out bumper according to various embodiments of the present disclosure.

FIG. 11 is another cross-sectional view of the air-spring assembly side of the upper portion of the suspension fork of FIG. 5 according to various embodiments of the present disclosure.

FIG. 12 is a top perspective view of an air bleeder valve on the damper assembly side of the suspension fork according to various embodiments of the present disclosure.

FIG. 13 is a top perspective view of a air bleeder valve on the air-spring assembly side of the suspension fork according to various embodiments of the present disclosure.

FIGS. 14 and 15 are additional cross-sectional views of an air-spring assembly side and a damper side, respectively, of an upper portion of the suspension fork according to various embodiments of the present disclosure.

### DETAILED DESCRIPTION

The present disclosure relates to a suspension fork having a bottom-out bumper assembly and/or an air pressure release assembly. Some suspension forks include bottom-out assemblies that handle “bottom-out” conditions that occur when a suspension fork reaches the end of its travel, typically during extreme compression events such as landing from a jump or encountering a large obstacle. Thus, some bottom-out assemblies include an elastomeric bumper designed to absorb impact forces during full compression of the suspension fork. The elastomeric bumper may be positioned near the end of the travel of the suspension fork to prevent metal-to-metal contact between components of the suspension system. In certain implementations, the bumper may be shaped and sized to fit within a specific region of the fork assembly, sometimes near a top end of an upper tube of the suspension fork.

The elastomeric bumper is often subjected to substantial forces during extreme compression events. These forces may cause the bumper to deform and potentially degrade and migrate into various cavities or spaces within the fork tubes. In some implementations, the bumper may be positioned into a cavity defined by a topcap of the suspension fork, where the topcap is a component located at the upper end of stanchion tubes of the suspension fork. This displacement of the bumper from its intended position may result in reduced effectiveness of the bottom-out system. In some cases, if the bumper becomes significantly misaligned or dislodged, subsequent bottoming out events may lead to undesired metal-to-metal contact between components of the suspension fork, potentially causing damage to the suspension system or compromising rider safety.

Accordingly, various embodiments are described herein for a suspension fork with improved bottom-out protection and/or air pressure release functionality. The suspension fork addresses challenges in maximizing bushing overlap while maintaining effective bottom-out systems. In some embodiments, the suspension fork may include upper and lower tubes slidably engaged with each other, defining an interior space. A topcap may be positioned on the upper tube, with a bottom-out assembly disposed within the interior space. The bottom-out assembly may include a bumper carrier positioned proximate to the topcap and an elastomeric bottom-out bumper affixed to the bumper carrier.

The bumper carrier may include a receiving surface and an annular wall coupled to the receiving surface. In some implementations, the elastomeric bottom-out bumper may be at least partially nested within the annular wall of the bumper carrier, and can include a surface that contacts the receiving surface of the bumper carrier. This configuration may help prevent the bumper from deforming inward and becoming lodged inside the lower tubes during extreme compression events.

In some embodiments, the bumper carrier can include a base plate, where the elastomeric bottom-out bumper can be overmolded onto the base plate. An overmolded bottom-out bumper may provide additional structural support and secure attachment of the bumper to the carrier. The elastomeric bottom-out bumper can include a first elastomeric portion overmolded onto a first side of the base plate, and a second elastomeric portion overmolded onto a second side of the base plate.

The topcap may include an interior portion comprising a plurality of coupling receptacles and/or locating features. It may be configured to threadably attach or otherwise couple to the body of the suspension fork. The bumper carrier may be secured to the topcap using a plurality of bumper carrier screws positioned through apertures in the bumper carrier and coupled to the coupling receptacles of the topcap in some implementations.

The bumper carrier may be configured to receive or retain an air pressure relief assembly. This assembly may be spring-loaded and, when manipulated, cause an air seal to disengage and equalize air pressure in the interior of the suspension fork with the outside ambient air pressure. This can allow for both bottom-out protection and air pressure relief functionality in a compact fork package.

Based on the foregoing, additional volume in the topcap region can be provided, which may help reduce air spring ramp-up characteristics. By retaining the bottom-out bumper to the topcap and providing structural support, the embodiments described herein aim to prevent the bumper from inverting into the lower tube, which can lead to undesired metal-to-metal contact at deeper travel positions. As such, improved performance and durability for suspension forks used in bicycles and other vehicles with inverted suspension systems are disclosed.

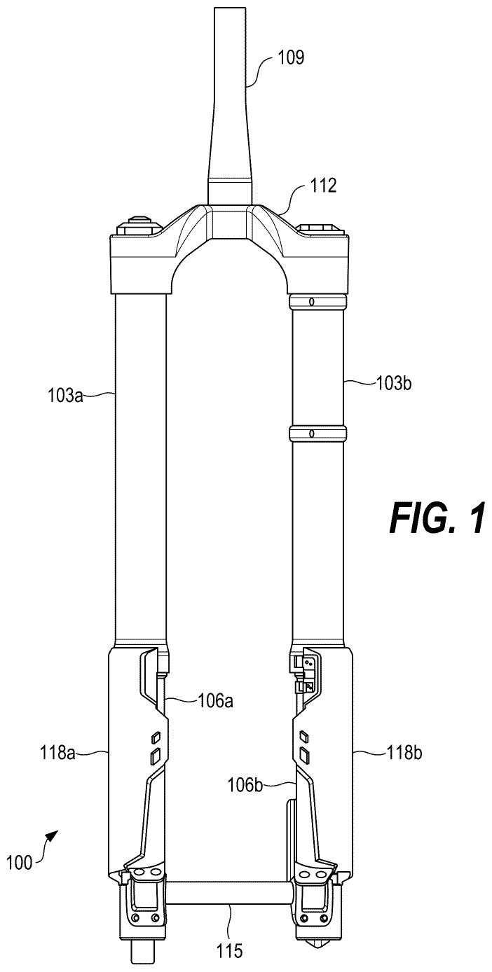

Turning now to the figures, FIGS. 1, 2, and 3 show front views of a suspension system according to various embodiments. The suspension system includes a suspension fork 100. While an inverted-type of suspension fork, referred to as an inverted suspension fork, is shown in various figures, it is understood that the components and functions described herein can also be implemented with other types of suspension forks (e.g., non-inverted suspension forks) and suspension systems without deviating from the principles of the disclosure.

Referring among FIGS. 1-3, the suspension fork 100 includes upper tubes 103a, 103b (collectively “upper tubes 103”) and lower tubes 106a, 106b (collectively “lower tubes 106”) which can be referred to as first tubes and second tubes, or vice versa. A first lower tube 106a is slidably engaged with a first upper tube 103a, and a second lower tube 106b is slidably engaged with a second upper tube 103b, as can be appreciated. To this end, the upper tubes 103 can have a diameter larger than a diameter of the lower tubes 106.

The slidable engagement between the upper tubes 103 and lower tubes 106 allows for compression and extension of the suspension fork 100 as a rider traverses various terrain on a bicycle or similar vehicle. When the rider encounters bumps, obstacles, or uneven surfaces, the lower tubes 106 telescopes into the upper tubes 103, absorbing shock and vibration, or vice versa. This movement helps to maintain tire contact with the ground, improving traction and control. As the suspension fork 100 rebounds after compression, the lower tubes 106 extend back out from the upper tubes 103, preparing the suspension for the next impact. The sliding action between the upper tubes 103 and the lower tubes 106 may be facilitated by bushings, seals, and lubricating oil, which work together to reduce friction and ensure consistent performance throughout the travel range of the suspension fork 100.

The suspension fork 100 further includes a steerer tube 109, a crown 112, and a through-axle 115. The crown 112 can couple the upper tubes 103 to one another, and the through-axle 115 can couple the lower tubes 106 to one another. The steerer tube 109 and the crown 112 can collectively form a crown-steerer assembly, and the steerer tube 109 can extend vertically from a central portion of the crown 112. The upper tubes 103 can be assembled by press-fit or pinch-bolts to the crown-steerer assembly. The suspension fork 100 can be fastened to the headtube of a bicycle, motorcycle, or other two-or three-wheeled vehicle through a set of headset bearings internal to the steerer tube 109 and steered by a bolt-on stem-handlebar assembly. This configuration can provide a secure connection between the suspension fork 100 and a frame of a vehicle while allowing for smooth steering control.

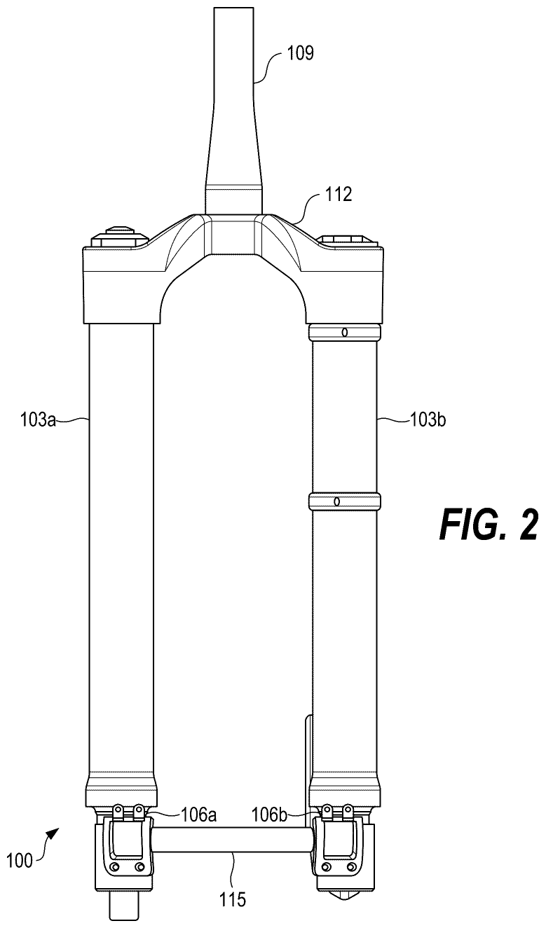

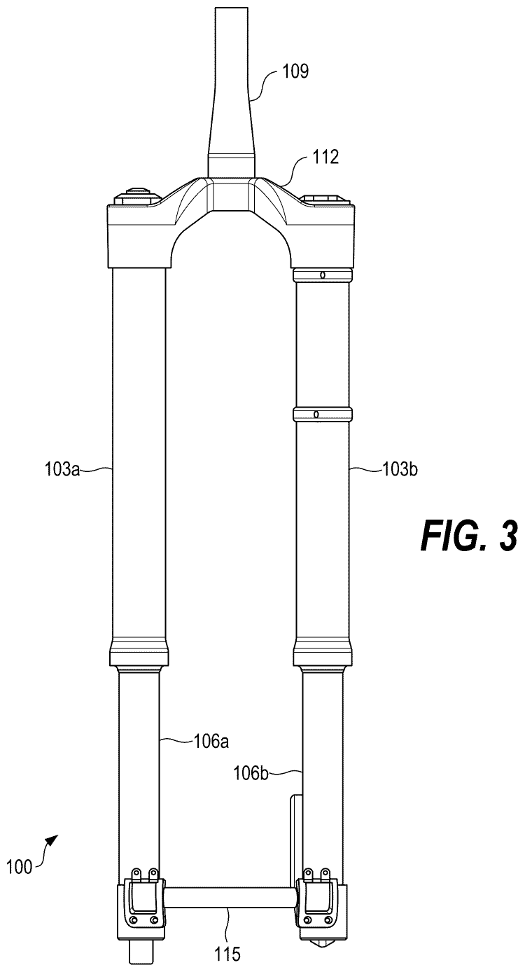

The through-axle 115 can be used to secure the suspension fork 100 to a vehicle. For example, the through-axle 115 can be passed through a hub of a wheel of a vehicle including, but not limited to, a front wheel of a bicycle or motorcycle. In FIG. 1, the suspension fork 100 includes lower guards 118a, 118b (collectively “lower guards 118”) that cover the lower tubes 106, protecting the lower tubes 106 from debris, impact, and other degrading forces. The lower guards 118 are omitted from view in FIGS. 2 and 3 for explanatory purposes, however. The lower guards 118 can be detachably attachable to the suspension fork 100 in some embodiments, or can be integral with the upper tubes 103.

The steerer tube 109, upper tubes 103, and lower tubes 106 of the suspension fork 100 can be constructed from a variety of materials selected to provide an optimal balance of strength, weight, and performance characteristics. In some implementations, these components, among other components of the suspension fork 100, can be fabricated from high-strength aluminum alloys, which offer excellent stiffness-to-weight ratios and corrosion resistance. Carbon fiber composites can also be utilized, particularly for the steerer tube 109 and upper tubes 103, to further reduce weight while maintaining structural integrity. In other cases, the lower tubes 106 can be constructed from steel alloys to enhance durability and withstand the stresses of repeated compression and extension cycles. Titanium alloys may be employed in premium fork designs, offering a combination of low weight, high strength, and vibration damping. The choice of materials for each component can be selected to meet specific performance requirements, rider preferences, and intended use cases of the suspension fork 100.

FIG. 2 shows the suspension fork 100 in full compression representing the maximum travel of the suspension fork 100, where the lower tubes 106 have telescoped fully into the upper tubes 103. During full compression, an air spring assembly, as will be described, is at its maximum pressure, provides the greatest resistance to further compression. Bottom-out bumpers positioned in the lower tubes 106, if present, are contacted by a piston, upper portions of the lower tubes, or other component to prevent metal-to-metal contact.

FIG. 2 illustrates an extreme end of the travel range of the suspension fork 100, which typically occurs during significant impacts or landings from large drops. FIG. 3, on the other hand, shows the suspension fork 100 in full extension or rebound. In this position, the lower tubes 106 are extended to their maximum length from the upper tubes 103, representing an opposite end of the travel range from the full compression shown in FIG. 2. This often occurs when the vehicle is unloaded or when the suspension is rebounding after absorbing an impact. The full extension position shown in FIG. 3 and the full compression position shown in FIG. 2 together illustrate a maximum available travel of the suspension fork 100.

In the fully extended position, an air spring assembly, as will be described, positioned in upper tubes 103 or lower tubes 106 may be at its lowest pressure state. This configuration may allow for maximum sensitivity to small bumps and vibrations at the beginning of travel of the suspension fork 100. The relationship between the upper tubes 103 and lower tubes 106 in this position may also affect initial stiffness and responsiveness of the suspension fork 100.

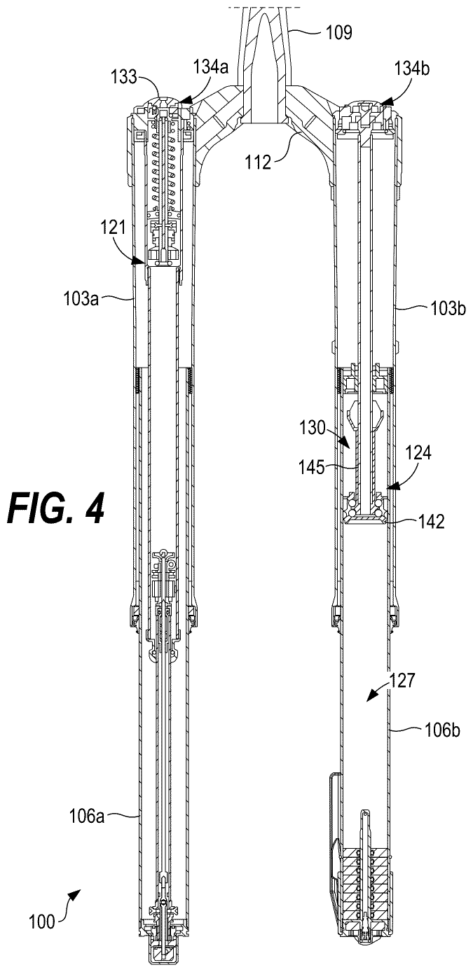

Turning now to FIG. 4, FIG. 4 shows a cross-sectional view of the suspension fork 100 depicting various internal components. The suspension fork 100 can include a damper assembly 121 positioned in the first upper tube 103a and/or the first lower tube 106a, and an air-spring assembly 124 positioned in the second upper tube 103b and/or the second lower tube 106b. In other words, the suspension fork 100 can include a damper assembly 121 positioned in tubes 103a, 106a on a first side of the suspension fork 100, and an air-spring assembly 124 positioned in the tubes 103b, 106b on a second side of the suspension fork 100.

This configuration illustrates a dual-chamber damper and air-spring assembly that can be provided in high-performance inverted suspension forks 100. The damper assembly 121 can be configured to control a rate of compression and rebound of the suspension fork 100, and provide adjustable damping characteristics to suit various riding conditions and preferences. The damper assembly 121 can include, for example, an upper piston, a lower pistol, shim stacks, and oil to create hydraulic resistance.

On the other hand, the air-spring assembly 124 is configured to provide a main spring force of the suspension fork 100. The air-spring assembly 124 utilizes compressed air to resist compression and return the suspension fork 100 to its extended position, shown in FIG. 3. To this end, the air-spring assembly 124 includes a positive air chamber 127 and a negative air chamber 130 positioned within inner walls of a cylinder defined by the upper tubes 103b and/or the lower tube 106b. The positive air chamber 127 and the negative air chamber 130 can be adjusted to fine-tune behavior of the suspension fork 100 throughout its travel range. By positioning these assemblies in separate legs of the fork, the design allows for optimal performance of each system without interference, while also distributing the functional components evenly across the suspension fork 100.

The suspension fork 100 can include a compression adjuster 133. For instance, a compression adjuster 133, positioned above the first upper tube 103a, can be used to adjust or control desired characteristics of the damper assembly 121. The compression adjuster 133 can integrate with or be part of one or more topcap assemblies 134a, 134b (collectively “topcap assemblies 134”). The compression adjuster 133 can be removed from the topcap assemblies 134 using a suitable tool, such as an Allen wrench or like tool.

The compression adjuster 133 can provide an interface for riders or vehicle operators to fine-tune the suspension characteristics of the suspension fork 100. In some implementations, each compression adjuster 133 can include a rotatable dial or knob that an operator can manipulate to adjust various suspension parameters. By rotating the dial clockwise or counterclockwise, the operator can increase or decrease compression damping, respectively.

The operator may adjust the compression damping using the compression adjuster 133 to control how quickly the suspension fork 100 compresses under load. A firmer setting achieved by rotating the dial clockwise, for example, may provide more resistance to compression, which can be beneficial for smoother terrain or when the rider desires a more responsive feel. Conversely, a softer setting achieved by rotating the dial counterclockwise, for example, may allow for easier compression, improving small bump sensitivity and traction on rough terrain.

In some embodiments, the compression adjuster 133 includes detents or click positions, providing tactile feedback to the operator and allowing for more precise and repeatable adjustments. Additionally, the compression adjuster 133 may include visual indicators, such as numbered markings or color-coded zones, which may help riders track and replicate their preferred settings across different riding conditions.

The negative air chamber 130 of the air-spring assembly 124 can be positioned at the top of the tubes 103b, 106b (or in only the upper tube 103b) and the positive air chamber 127 can be positioned at the bottom of the tubes 103b, 106b (or in only the lower tube 106b). These chambers work in conjunction to provide a balanced and responsive suspension action. The negative air chamber 130 can help to reduce initial breakaway force required to initiate suspension movement, improving small bump sensitivity and providing a desirable feel at the beginning of the travel. As the suspension fork 100 compresses, the positive air chamber 127 can provide increasing resistance, helping to support the operator's weight and prevent bottoming out on larger impacts. The relative volumes and pressures of these chambers can be adjustable, allowing riders to fine-tune the behavior of the suspension fork 100 to suit preferences and riding conditions.

The air-spring assembly 124 can include an air piston 142 coupled to an air shaft 145 which can permit transfer of air pressure between the positive air chamber 127 and the negative air chamber 130. The air shaft 145 can be hollow in some implementations, or might not be hollow in others. The air piston 142 can translate or otherwise move within the cylinder in response to compression and extension of the suspension fork 100. In some implementations, the air shaft 145 can extend from the air piston 142 towards the upper portion of the suspension fork 100, passing through the negative air chamber 130. This can facilitate air transfer between chambers during fork travel, providing spring-like characteristics. The air piston 142 and the air shaft 145 can include seals to maintain proper air pressure separation between chambers and prevent unwanted air loss.

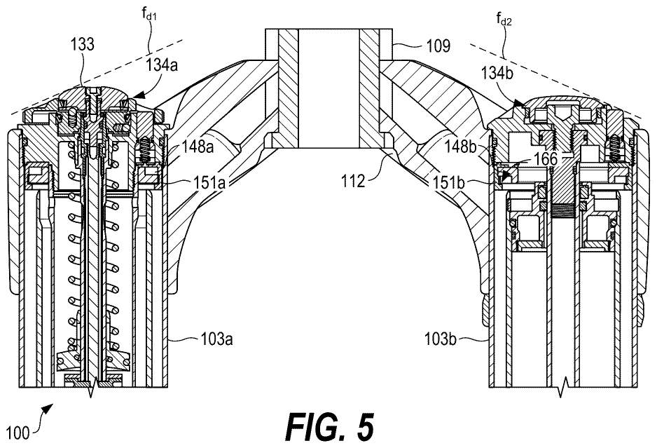

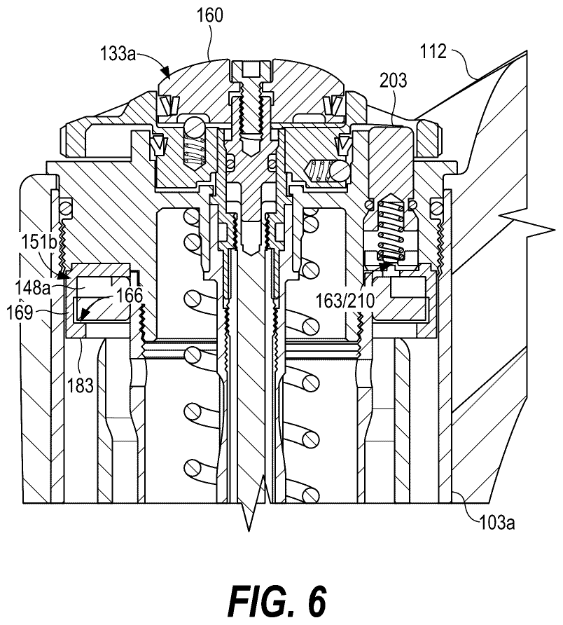

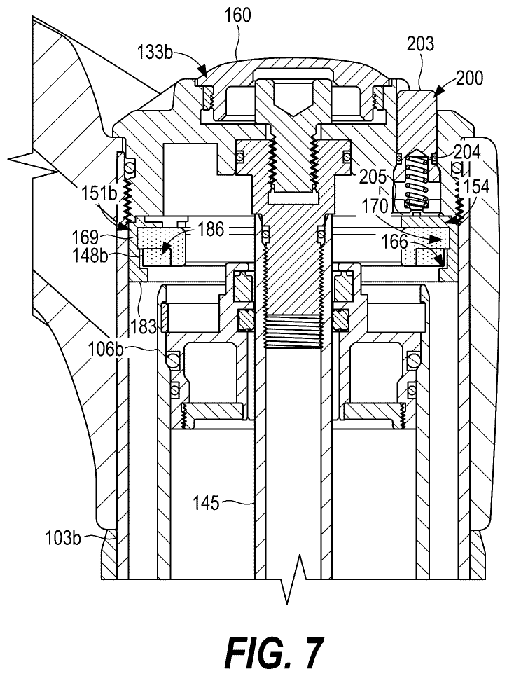

FIG. 5 shows a cross-sectional view of an upper portion of the suspension fork 100 of FIG. 4. FIG. 6 shows an upper cross-sectional view of a damper assembly-side of the upper portion of the suspension fork 100. FIG. 7 shows an upper cross-sectional view of an air-spring assembly-side of the suspension fork 100.

First, with reference to FIG. 5, angles, referred to as frame downtube angles or frame downtubes f_{d1} and f_{d2}, are shown on both sides of the suspension fork 100. The suspension fork 100 can be sized and positioned to provide adequate clearance between the compression adjuster 133, topcap assemblies 134, air bleed valve assemblies, etc., and the frame downtubes f_{d1} and f_{d2} when the fork is turned 90 degrees, for example. This clearance can help prevent interference or contact between these components during steering maneuvers, particularly in tight turning situations.

On the suspension fork 100, reaction loads and the resulting friction at the bushings can be reduced by maximizing the distance between the upper and lower bushings which is commonly referred to as “bushing overlap.” Maximizing bushing overlap on an inverted-type suspension fork 100 can be accomplished by maximizing a length of the lower tube 106. When the length of the lower tube 106 is maximized on the suspension fork 100 (e.g., an inverted-type single crown bicycle fork), bottom-out bumpers 148a, 148b (collectively “bottom-out bumpers 148”) are generally positioned proximate to the topcap assemblies 134 and are designed to prevent metal-on-metal contact.

Traditionally, bottom-out bumpers 148 are pressed-in or stretched over parts where they are located. However, during use, the bottom-out bumpers 148 can deform inward at the lower tubes 106 and become lodged inside of the lower tubes 106. If this inversion of bottom-out bumper into the lower tube 106 occurs, the suspension fork 100 will have a metal-to-metal contact at a deeper travel position, which is undesirable. As such, the bottom-out bumper 148 can be positioned in or otherwise proximate to the topcap assembly 134, which can provide structural support, retain integrated air pressure release buttons, and provide additional volume in the topcap assembly 134 to reduce air spring ramp up in an upper tube assembly.

The suspension fork 100 can include one or more topcap assemblies 134, such as a first topcap assembly 134a and a second topcap assembly 134b (collectively “topcap assemblies 134”). Referring to FIGS. 5-7 collectively, the first topcap assembly 134a is shown as being positioned in or on a first upper tube 103a, and the second topcap assembly 134b is shown as being positioned in or on a second upper tube 103b.

The topcap assembly 134 can be threadably attached to the upper tube 106 or other portion of the suspension fork 100. Thus, the topcap assembly 134 can be removed using a screwdriver, Allen wrench, or like tube. It is understood, however, that other types of connections can be employed to couple the topcap assembly 134 to the tubes of the suspension fork 100, such as a snap-on connection, interference connection, and so forth. In some embodiments, a first portion of the topcap assembly 134 is positioned external the upper tube 103 (e.g., on a top surface of the upper tube 103), whereas a second portion of the topcap assembly 134 is positioned internal the upper tube 103.

One or more bottom-out assemblies 151a, 151b (collectively “bottom-out assemblies 151”) can be disposed within the interior of the tubes of the suspension fork 100. The bottom-out assemblies 151 can include a first bottom-out assembly 151a and a second bottom-out assembly 151b, for example. Alternatively, the suspension fork 100 can include only a single bottom-out assembly 151.

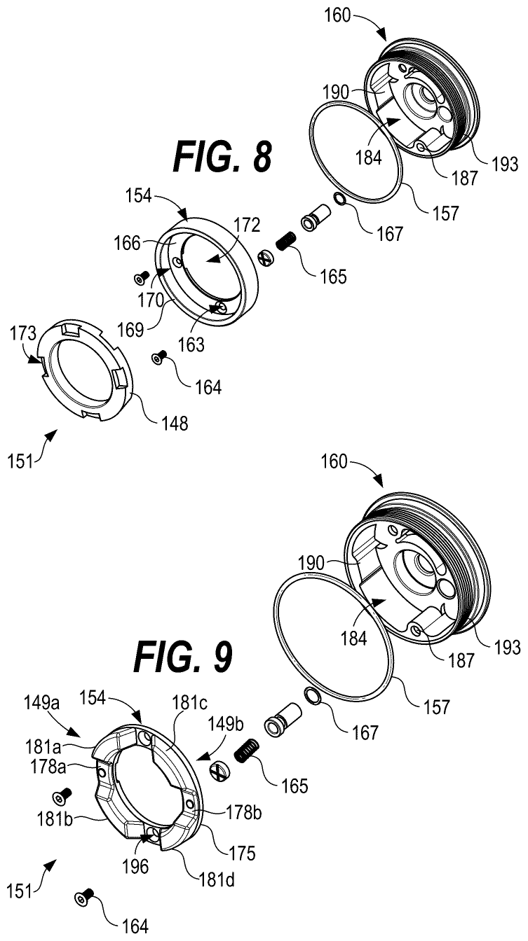

Referring now to FIG. 8, an example embodiment of a bottom-out assembly 151 is shown. One or more of the bottom-out assemblies 151 of the suspension fork 100 can include a carrier part, referred to as a bumper carrier 154, and a bottom-out bumper 148 positioned proximate to a topcap 160 of a topcap assembly 134 (FIG. 7). The bumper carrier 154 is configured to be positioned against a bottom surface of the topcap 160. A seal 157 can be positioned between the bumper carrier 154 and the topcap 160 to facilitate a seal therebetween. The bumper carrier 154 can be coupled to the topcap 160 using one or more connection mechanisms positioned through bumper carrier apertures 163, which can include screws 164, springs 165, washers 167, and so on. In some embodiments, referring back to FIG. 6, one or more of the bumper carrier apertures 163 may be configured to align with an aperture 210 in an air pressure relief assembly 200 to collectively define a channel that permits air to travel though the channel.

Referring again to FIG. 8, the bumper carrier 154 can be formed of a generally rigid material, such as a rigid polymer, a composite material, a metal material, or the like. The bottom-out bumper 148 can be removably affixed to the bumper carrier 154 which, in turn, can be affixed to the topcap 160. In some embodiments, the bumper carrier 154 includes an annular groove 170 defined by the annular wall 169. The bottom-out bumper 148 can be formed of an elastomeric material configured to snap into, press fit, or otherwise be positioned in the annular groove 170. The annular groove 170 can be surrounded by protrusions or ridges that retain the bottom-out bumper 148 therein.

This configuration allows the elastomeric bottom-out bumper 148 to be securely retained within the bumper carrier 154 while allowing flexibility and compression during impacts. As such, the annular wall 169 and the receiving surface 166 can provide a mechanical interface that helps prevent the bottom-out bumper 148 from becoming dislodged or deforming inward during extreme compression events. The elastomeric material of the bottom-out bumper 148 can deform to absorb impact forces while the rigid structure of the bumper carrier 154 maintains proper positioning and alignment within the suspension fork 100.

The bumper carrier 154 can include a receiving surface 166 and an annular wall 169 coupled to and projecting from the receiving surface 166. The bottom-out bumper 148 can at least partially nest within the annular wall 169 and/or the annular groove 170, if present. Thus, the annular wall 169 acts as a retention feature. The retention feature including, but not limited to, the annular wall 169 may thus provide a snap-fit mechanism configured to detachably or fixedly secure the bottom-out bumper 148 to the bumper carrier 154. For instance, the bottom-out bumper 148 may snap into and forms a snap-fit connection with the bumper carrier 154 based on a geometry of the annular wall 169. The bottom-out bumper 148 has a surface facing the bumper carrier 154 that contacts the receiving surface 166 of the bumper carrier 154. The receiving surface 166 can be annular, and can include an opening 172.

In some implementations, the bumper carrier 154 may include one or more cut-outs or notches 173 strategically positioned within its body. The notches 173 may be areas where material is not present or selectively removed from the bumper carrier 154. The placement and geometry of the notches 173 may be designed to facilitate controlled deformation of the bumper carrier 154 during compression events. Thus, the notches 173 may vary in shape, size, and location depending on the desired performance characteristics. For example, the bumper carrier 154 may include rectangular cut-outs extending along a periphery.

In other implementations, the cut-outs may be circular, oval, or irregularly shaped voids positioned at various points around the bumper carrier 154. The strategically placed notches 173 may allow certain portions of the bumper carrier 154 to flex or deform in a predetermined manner when subjected to compressive forces. This controlled deformation may help distribute impact forces more evenly across the bottom-out bumper 148 and other components of the suspension fork 100. In some aspects, the notches 173 may be arranged in patterns that create zones of different stiffness within the bumper carrier 154. This variable stiffness may contribute to a more progressive compression feel as the suspension fork 100 approaches full travel.

Moving along to FIG. 9, another example embodiment of a bottom-out assembly 151 is shown. The bumper carrier 154 in FIG. 9 includes a base plate 175, which can be formed of a generally rigid material, such as a rigid polymer, a composite material, a metal alloy, or the like The bottom-out bumper 148 can be overmolded onto the base plate 175 using a suitable overmolding process, or can be overmolded or otherwise formed and permanently affixed to the base plate 175 using a suitable adhesive. The bottom-out bumper 148 can thus be manufactured in various sizes and geometries.

In some embodiments, the bottom-out bumper 148 includes a first bottom-out bumper portion 149a overmolded onto a first side of the base plate 175, and a second elastomeric portion 149b overmolded onto a second side of the base plate 175. Collectively, the first bottom-out bumper portion 149a and the second bottom-out bumper portion 149b form up the bottom-out bumper 148. Thus, the first bottom-out bumper portion 149a and the second bottom-out bumper portion 149b can each be formed of an elastomeric material.

In some embodiments, at least one of the first bottom-out bumper portion 149a and the second bottom-out bumper portion 149b includes a non-uniform body. For instance, the first bottom-out bumper portion 149a can include one or more recessed portions and one or more stepped (or raised) portions. Similarly, the second bottom-out bumper portion 149b can include one or more recessed portions and one or more stepped (or raised) portions.

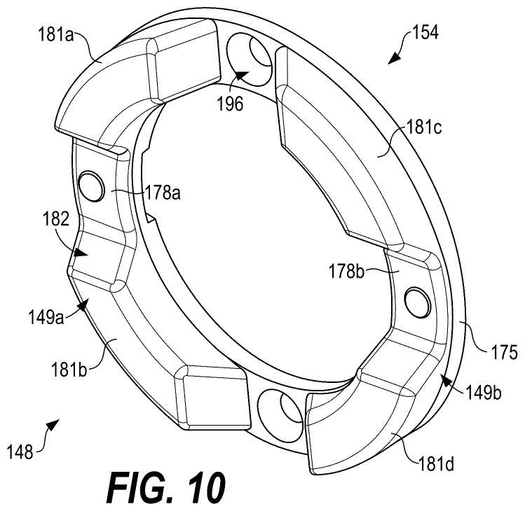

In the example shown, the first bottom-out bumper portion 149a includes a recessed portion 178a positioned between a first stepped portion 181a and a second stepped portion 181b, and the second bottom-out bumper portion 149b includes a recessed portion 178b positioned between a third stepped portion 181c and a fourth stepped portion 181d. Each of the stepped portions 181a . . . 181d (collectively “stepped portions 181”) may have a height relative to the base plate 175 that is greater than a height of the recessed portions 178a, 178b (collectively “recessed portions 178”), as can be appreciated. The base plate 175 can include apertures 196 to connect the base plate 175 (and the bottom-out bumper 148 co-molded or otherwise affixed thereon) to the topcap 160. Edges 182 of the stepped portion 181, shown in FIG. 10, may gradually slope or taper down to meet the recessed portion 178, creating a transition between the two heights.

The stepped configuration of the elastomeric body can provide progressive resistance during compression, allowing for a more controlled bottom-out behavior. For instance, the increased height of the stepped portion 181 can help in managing larger impacts or more severe compression events, compressing until a tube or other bottom-out component contacts the recessed portion 178. Thus, in some embodiments, the stepped portion 181 and the recessed portion 178 work together to provide a variable rate of compression resistance as the suspension fork 100 approaches full compression. The recessed portion 178 allows the rubber to deform or deflect into the recessed portions 178, allowing for a softer bottom-out which provides a softer bottom-out bumper spring curve, as can be appreciated. Thus, instead of providing a bottom-out bumper 148 with a generally uniform ring of material which will create a harsh bottom-out event, the recessed portions 178 allow for controlled deformation for a smoother and cushioned bottom-out event. The recessed portions 178a, 178b can be positioned symmetrically on opposing sides of the base plate 175.

The combination of these two portions with different heights may also help in tuning the overall bottom-out characteristics of the suspension fork, allowing designers to adjust the force curve experienced during extreme compression events. This design may contribute to improved rider comfort and control, especially during aggressive riding or when encountering large obstacles.

Referring again to FIG. 7, FIG. 7 illustrates a cross-sectional view of the suspension fork 100 where a lower tube 106b is approaching the bottom-out bumper 148b. As the suspension fork 100 compresses, the lower tube 106b may move upward within the upper tube 103b, reducing the distance between the lower tube 106b and the bottom-out bumper 148b. This movement may occur during significant compression events of the suspension fork 100, such as when encountering large obstacles or landing from jumps. As the lower tube 106b approaches the bottom-out bumper 148, the air spring assembly 124 may provide increasing resistance to compression. The proximity of the lower tube 106b to the bottom-out bumper 148b may indicate that the suspension fork 100 is nearing the end of its travel range. The bottom-out bumper 148b may be positioned to prevent metal-to-metal contact between the lower tube 106b and other components of the suspension fork 100 at full compression.

The annular wall 169 projects from the receiving surface 166, where a ledge 183 of the receiving surface 166 engages with the bottom-out bumper 148 to retain the bottom-out bumper 148 in the bumper carrier 154. In some embodiments, the ledge 183 engages with an annular indentation 186 of the bottom-out bumper 148. The bottom-out bumper 148 thereby nests within the annular wall 169 and an annular groove 170 (FIG. 8).

Referring again to FIGS. 8 and 9, the topcap 160 can include an interior portion 184. The interior portion 184 can include one or more coupling receptacles 187 and one or more locating features 190. Locating features 190 can include notches or ridges that can align for corresponding locating features of the seal 157, the base plate 175, the bumper carrier 154, and so on. The topcap 160 can further include threads 193 such that the topcap 160 can threadably attach to a tube or other body of the suspension fork 100, or to another component of the topcap assembly 134.

The threads 193 can be positioned on a neck portion of the topcap 160 that is configured to be nested in the upper tube 103 of the suspension fork 100. A top portion of the topcap 160 can be coupled to the neck portion, where the top portion of the topcap 160 is adapted to be positioned on or above an upper surface of the suspension fork 100. Like the bumper carrier 154 of FIG. 8, the base plate 175 of FIG. 9 can be coupled to the topcap 160 using one or more connection mechanisms positioned through base plate apertures 196, which can include screws 164, springs 165, washers 167, and so on.

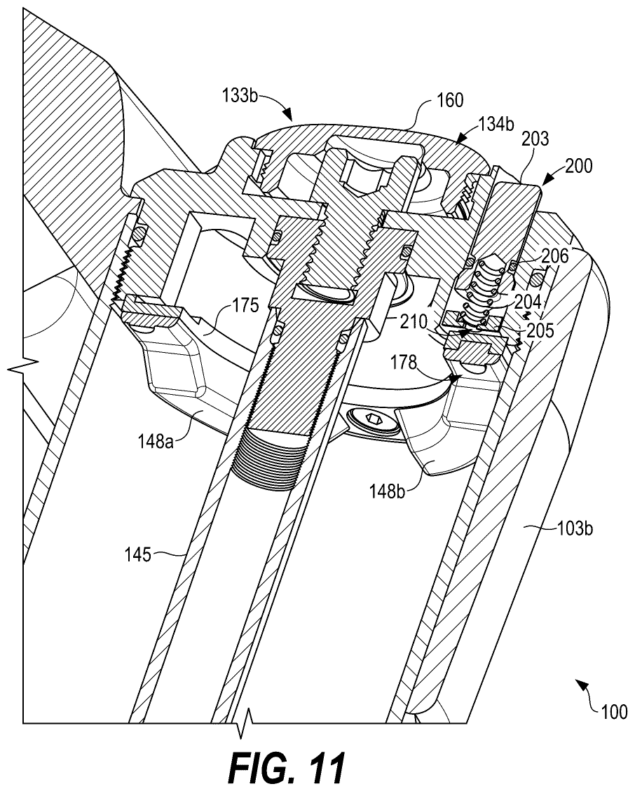

Turning now to FIG. 11, a perspective, cross-sectional view of an upper portion of the suspension fork 100 is shown according to various embodiments. The topcap assemblies 134a, 134b can be configured to receive or retain an air pressure relief assembly 200 in some embodiments. As such, the air pressure relief assembly 200 can thus be integrated with a respective topcap assembly 134. The air pressure relief assembly 200 can act as an air bleeder valve and, as such, the air pressure relief assembly 200 can include, for example, a release mechanism 203, a spring 204, and an air seal 206, among other components.

When the release mechanism 203 is manipulated, the spring 204 is compressed and the air seal 206 moves or is otherwise disengaged. Upon the air seal 206 disengaging, air pressure in the interior of the suspension fork 100 is equalized with outside ambient air pressure. The spring 204 returns the release mechanism 203 to its original position with the air seal 206 reengaged. To this end, the spring 204 can bias the release mechanism 203 upwards in various implementations, although it is understood that other orientations and biasing directions can be employed. Positioning the release mechanism 203 on an upper portion of the suspension fork 100 may help prevent lubricating oil from being inadvertently released through the air pressure relief assembly 200. This configuration may allow for air pressure equalization while minimizing the risk of oil loss, which could potentially compromise the lubrication and damping performance of the suspension fork 100. Referring again to FIG. 7, the base plate 175 retains the air pressure relief assembly 200, and biases it upwards towards the topcap assembly 134. For instance, a location of the base plate 175 can retain the spring 204 and a spring plate surface 205 in a preloaded state, which biases a release mechanism 203 upwards, preventing leak of air during riding of the bicycle.

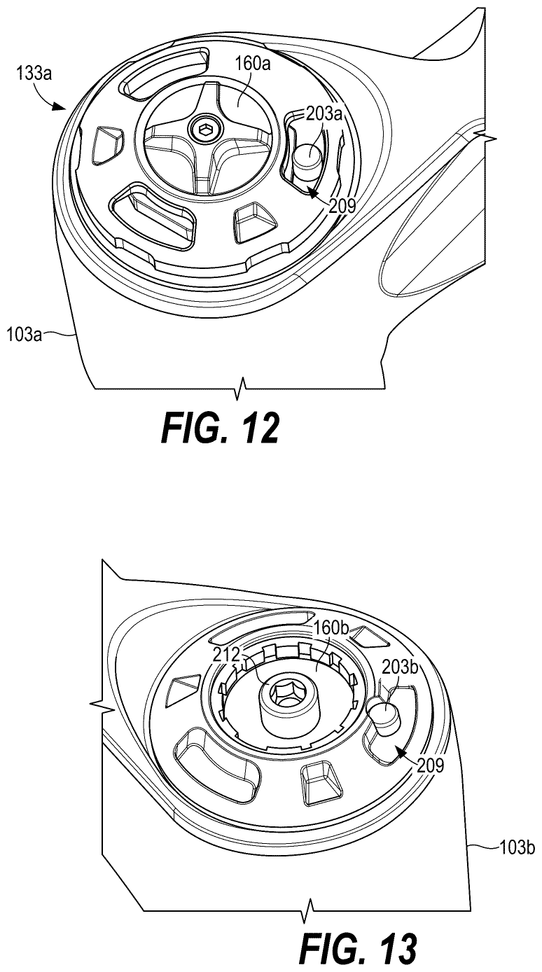

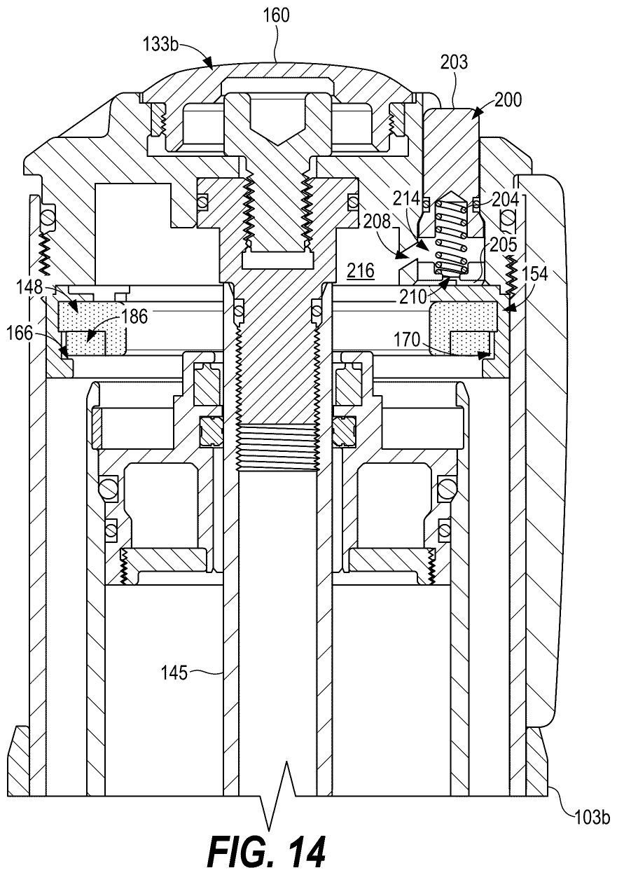

Turning now to FIGS. 12 and 13, top perspective views of the suspension fork 100 is shown according to various embodiments. More specifically, a top perspective view of the first upper tube 103a is shown in FIG. 12, whereas a top perspective view of the second upper tube 103b is shown in FIG. 13. FIG. 12 shows the compression adjuster 133 mounted to the first upper tube 103a. The assembly includes a first topcap 160a that interfaces with the first upper tube 103a. In some implementations, the topcap 160 incorporates features to facilitate adjustable compression settings. For example, the topcap 160 may include machined pockets or detents arranged in an annular pattern which can interact with a spring-loaded ball mechanism to provide tactile feedback as compression settings are adjusted.

A first release mechanism 203a of an air pressure relief assembly 200 can be integrated thereon, positioned near the outer edge of the topcap 160. The mechanism 203a may function as an air pressure relief button or an air bleeder valve, as can be appreciated. In some aspects, the topcap 160 may include one or more slots 209 aligned with the release mechanism 203a, such that the release mechanism 203a is situated in and projects from a slot 209. The slots 209 may thus allow access to the release mechanism 203a even when additional adjustment knobs are installed over the topcap 160.

The compression adjuster 133 thus can include a knob that provides various levels of compression adjustment, such as low-speed or high-speed compression tuning, where the configuration of the compression adjuster 133 can vary depending on the sophistication level of the suspension fork 100. For example, in some basic models, the suspension fork 100 may not include any compression adjuster 133. In other models, a single compression adjuster 133 may be provided, which may control high-speed compression. This single knob may be positioned centrally on the topcap 160. More advanced models of the suspension fork 100 may feature multiple compression adjusters 133. These may include separate knobs for low-speed and high-speed compression adjustment. The compression adjuster 133 may be concentrically arranged, with the high-speed compression adjustment knob positioned centrally and the low-speed compression adjustment knob surrounding it.

Thus, the one or more compression adjusters 133 can include a slot 209 that aligns with the release mechanism 203a, allowing access to air pressure relief when the compression adjusters 133 are installed. This can ensure that the air pressure relief functionality remains accessible regardless of the compression adjustment configuration.

FIG. 13, on the other hand, depicts a second topcap 160b interfacing with the second upper tube 103b. A second release mechanism 203b is positioned near the outer edge of the topcap 160b, serving as an air pressure relief button for a second side of the suspension fork 100. The second upper tube 103b does not include a compression adjuster 133 in this embodiment; however, the release mechanism 203 is similarly situated in a slot 209. The compression adjuster valve assemblies shown in FIGS. 12 and 13 may be arranged symmetrically on both sides of the suspension fork 100, with each assembly maintaining similar functionality through their respective configurations. This arrangement may allow for independent adjustment and air pressure relief on both the damper side and air spring side of the suspension fork 100.

The topcap 160 of FIGS. 12 and 13 may be designed for removal and installation using a hand of an operator or common tools. In some implementations, the topcap 160 may include a centrally located hand screw that can be turned by hand to remove the topcap 160. Alternatively, the topcap 160 may include a centrally located screw or bolt 212 with a hexagonal socket head. This configuration may allow for removal of the topcap 160 using an Allen wrench or similar hexagonal tool.

The bolt 212 securing the topcap 160 may be accessed through an opening in the center of any adjustment knobs present on the topcap assembly. To remove the topcap 160, a user may first remove any external adjustment knobs if present. The user may then insert an appropriately sized Allen wrench or hexagonal tool into the socket head of the bolt 212. By rotating the Allen wrench counterclockwise, the user may loosen and eventually remove the bolt 212, allowing the topcap 160 to be lifted away from the upper tube. This design may provide a secure attachment while also allowing for relatively quick and easy access to internal components for maintenance or adjustment.

When reinstalling the topcap 160, the user may reverse the process, ensuring proper alignment of any locating features before tightening the central screw with the Allen wrench. Care may be taken not to over-tighten the bolt 212, as this could potentially damage the components or compromise the seal between the topcap 160 and the upper tube.

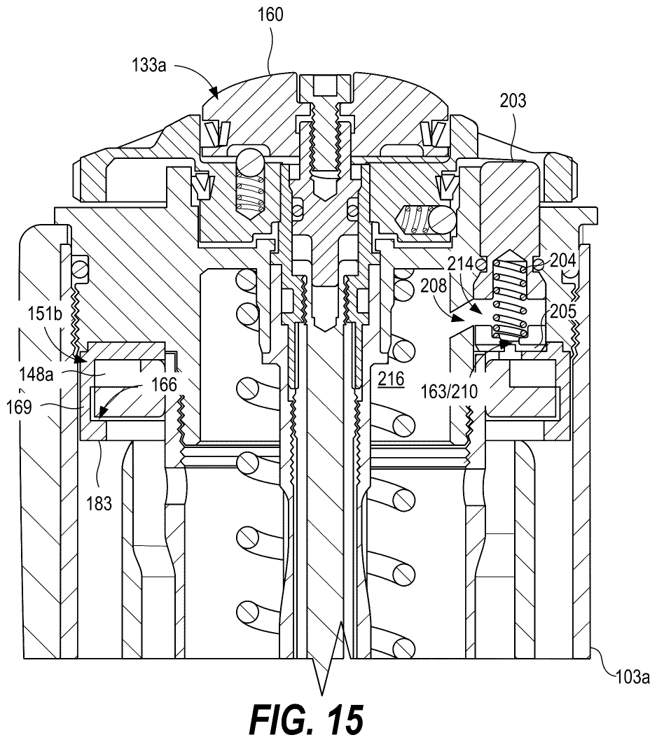

Turning now to FIGS. 14 and 15, additional cross-sectional views of the air-spring assembly side and the damper side, respectively, of the upper portion of the suspension fork 100 are shown according to various embodiments. In some implementations, it has been found that the release mechanism 203 of the air pressure relief assembly 200 equalizes pressure at a rate that may be slower than desired for certain applications or user preferences. To address this, FIGS. 14 and 15 illustrate a channel 208 that may be incorporated to enhance the air release or equalization characteristics of the system.

The channel 208 may couple an air release chamber 214 of the release mechanism 203 to an inner chamber 216 of the fork leg, which may facilitate more rapid pressure equalization between the interior of the suspension fork 100 and outside ambient air pressure (e.g., atmosphere). The channel 208 may be formed as a cross-hole that can be drilled or otherwise formed in a wall between the air release chamber 214 and the inner chamber 216. This configuration may allow for improved air flow characteristics when the release mechanism 203 is actuated, providing users with more responsive air pressure relief functionality. The channel 208 may be sized and positioned to optimize the balance between controlled air release and the structural integrity of the surrounding components.

FIGS. 14 and 15 further illustrate that the bumper carrier 154 is configured to contact and support the air pressure relief assembly 200. A top surface of the bumper carrier 154 may contact and bias the spring 204 and a spring plate surface 205 upwards in a closed position. The upward biasing force applied by the bumper carrier 154 may help maintain the air seal 206 in its engaged, sealed position during normal operation, preventing unwanted air loss while the suspension fork 100 is in use. The positioning of the channel 208 may enable communication between the chambers when the release mechanism 203 is actuated, allowing for efficient pressure equalization. In some embodiments, one or more apertures in the base plate 175 of the various bumper carrier 154 embodiments described herein may align with an aperture 210 in an air pressure relief assembly 200 to collectively define a channel that permits air to travel though, facilitating the release of air inside the inner chamber 216.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A suspension fork, comprising:
an upper tube;
a lower tube slidably engaged with the upper tube; and
a carrier part positioned in the upper tube, the carrier part configured to retain a bottom-out bumper.

2. The suspension fork of claim 1, wherein the carrier part comprises a receiving surface and an annular wall coupled to the receiving surface, the annular wall configured to at least partially nest the bottom-out bumper.

3. The suspension fork of claim 2, wherein the annular wall comprises an annular groove configured to retain the bottom-out bumper.

4. The suspension fork of claim 3, wherein the annular groove is surrounded by protrusions that retain the bottom-out bumper within the annular groove.

5. The suspension fork of claim 1, wherein the carrier part comprises a base plate, and wherein the bottom-out bumper is overmolded onto the base plate.

6. The suspension fork of claim 5, wherein the bottom-out bumper comprises a first elastomeric portion overmolded onto a first side of the base plate, and a second elastomeric portion overmolded onto a second side of the base plate.

7. The suspension fork of claim 6, wherein at least one of the first elastomeric portion and the second elastomeric portion comprises at least one recessed portion and at least one stepped portion, the at least one stepped portion having a height relative to the base plate that is greater than a height of the at least one recessed portion.

8. A bumper carrier for a bottom-out assembly of a suspension fork, comprising:
a base plate and a retention feature coupled to the base plate, the retention feature configured to secure a bottom-out bumper to the bumper carrier.

9. The bumper carrier of claim 8, wherein the retention feature comprises an annular wall integral with the base plate, the annular wall configured to at least partially nest the elastomeric bottom-out bumper.

10. The bumper carrier of claim 9, wherein the annular wall defines an annular groove configured to detachably retain the bottom-out bumper, wherein the annular groove is surrounded by protrusions that detachably retain the bottom-out bumper within the annular groove.

11. The bumper carrier of claim 8, wherein the bottom-out bumper is formed of an elastomeric material.

12. The bumper carrier of claim 8, wherein the base plate comprises a plurality of apertures configured to receive fasteners for coupling the bumper carrier to a topcap of the suspension fork.

13. The bumper carrier of claim 8, wherein the retention feature comprises a snap-fit mechanism configured to detachably secure the bottom-out bumper to the bumper carrier, wherein the bottom-out bumper snaps into and forms a snap-fit connection with the bumper carrier.

14. The bumper carrier of claim 8, wherein the bumper carrier is configured to contact and support an air pressure release assembly, a top surface of the bumper carrier biasing a spring and a spring plate surface upwards in a closed position, wherein a channel is positioned in a wall between an air pressure release chamber and an inner chamber of a suspension fork leg.

15. A bumper carrier for a suspension fork, comprising:
a base plate configured to be coupled to a component of the suspension fork; and
at least one elastomeric portion permanently affixed to the base plate.

16. The bumper carrier of claim 15, wherein the at least one elastomeric portion is overmolded onto the base plate.

17. The bumper carrier of claim 15, wherein the at least one elastomeric portion comprises a first elastomeric portion affixed to a first side of the base plate and a second elastomeric portion affixed to a second side of the base plate.

18. The bumper carrier of claim 17, wherein at least one of the first elastomeric portion and the second elastomeric portion comprises at least one recessed portion and at least one stepped portion, the at least one stepped portion having a height relative to the base plate that is greater than a height of the at least one recessed portion.

19. The bumper carrier of claim 15, wherein the base plate comprises a plurality of apertures configured to receive fasteners for coupling the bumper carrier to the component of the suspension fork, wherein the component is a topcap.

20. The bumper carrier of claim 15, wherein the at least one elastomeric portion is bonded to the base plate using an adhesive.
